(19) United States
(12) Patent Application Publication
(10) Pub. No.: US 2026/0302942 A1
(43) Pub. Date: Oct. 1, 2026

(54) CONTROL CIRCUIT OF SWITCHING REGULATOR CIRCUIT AND METHOD FOR CONTROLLING SWITCHING REGULATOR CIRCUIT

(71) Applicant: CYNTEC CO., LTD., Hsinchu (TW)

(72) Inventor: Hsuan-Ju Chen, Hsinchu (TW)

(73) Assignee: CYNTEC CO., LTD., Hsinchu (TW)

(21) Appl. No.: 19/093,276

(22) Filed: Mar. 28, 2025

(51) Int. Cl. H02M 3/156; H02M 1/00

(52) U.S. Cl. CPC H02M 3/156; H02M 1/0025

(57) ABSTRACT

A control circuit of a switching regulator circuit includes a reference signal generation circuit, an oscillator circuit, a feedback circuit, a combining circuit, a comparator circuit, and a PWM control circuit. The reference signal generation circuit generates an adjusted reference voltage according to a first reference voltage and a PWM signal. The oscillator circuit generates a sawtooth wave signal and a clock signal. The feedback circuit generates a feedback voltage according to an output voltage of the switching regulator circuit. The combining circuit combines the adjusted reference voltage and the sawtooth wave signal to generate an adjusted sawtooth wave signal. The comparator circuit compares a first input signal derived from the feedback voltage and a second input signal derived from the adjusted sawtooth wave signal, to output a comparison signal. The PWM control circuit generates the PWM signal according to the comparison signal and the clock signal.

### BACKGROUND OF THE DISCLOSURE

### 1. Field of the Disclosure

The present disclosure relates to a voltage converter design, and more particularly, to a control circuit of a switching regulator circuit (i.e., a voltage converter circuit operating under a pulse-width modulation (PWM) mode) and a method for controlling the switching regulator circuit.

### 2. Description of the Prior Art

With advanced development in technology, various electronic products, such as notebooks and mobile phones, have been presented and are widely used in daily life. In general, a voltage converter circuit is required for providing operating power for the electronic products. The voltage converter circuit may be a buck converter that is capable of converting a high alternating current (AC) voltage or direct current (DC) voltage to a low and stable DC voltage for normal operations of the electronic products. The voltage converter circuit may be designed to adopt one of several conventional control schemes, including voltage mode PWM control, peak current mode PWM control, ripple-based constant on-time (RBCOT) control, V²COT control, etc. However, each of the conventional control schemes has its own drawbacks. Thus, there is a need for an innovative voltage converter design which is free of drawbacks suffered by the conventional control schemes.

### SUMMARY OF THE DISCLOSURE

One of the objectives of the present disclosure is to provide a control circuit of a switching regulator circuit and a method for controlling the switching regulator circuit.

According to a first aspect of the present disclosure, an exemplary control circuit of a switching regulator circuit is disclosed. The exemplary control circuit includes a reference signal generation circuit, an oscillator circuit, a feedback circuit, a combining circuit, a comparator circuit, and a PWM control circuit. The reference signal generation circuit is configured to generate an adjusted reference voltage according to a first reference voltage and a PWM signal. The oscillator circuit is configured to generate a sawtooth wave signal and a clock signal. The feedback circuit is configured to generate a feedback voltage according to an output voltage of the switching regulator circuit. The combining circuit is configured to combine the adjusted reference voltage and the sawtooth wave signal to generate an adjusted sawtooth wave signal. The comparator circuit includes a first input terminal configured to receive a first input signal derived from the feedback voltage, a second input terminal configured to receive a second input signal derived from the adjusted sawtooth wave signal, and an output terminal configured to output a comparison signal. The PWM control circuit is configured to generate the PWM signal according to the comparison signal and the clock signal.

According to a second aspect of the present disclosure, an exemplary method for controlling a switching regulator circuit is disclosed. The exemplary method includes: generating an adjusted reference voltage according to a reference voltage and a pulse-width modulation (PWM) signal; generating a sawtooth wave signal and a clock signal; generating a feedback voltage according to an output voltage of the switching regulator circuit; combining the adjusted reference voltage and the sawtooth wave signal to generate an adjusted sawtooth wave signal; comparing a first input signal derived from the feedback voltage and a second input signal derived from the adjusted sawtooth wave signal, to generate and output a comparison signal; and generating the PWM signal according to the comparison signal and the clock signal.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first switching regulator circuit according to an embodiment of the present disclosure.

FIG. 2 is a flowchart illustrating a PWM control scheme of the switching regulator circuit shown in FIG. 1 according to an embodiment of the present disclosure.

FIG. 3 is a diagram illustrating waveforms of a PWM signal and an adjusted reference voltage shown in FIG. 1 according to an embodiment of the present disclosure.

FIG. 4 is a diagram illustrating a first alternative design of a current source shown in FIG. 1 according to an embodiment of the present disclosure.

FIG. 5 is a diagram illustrating a second alternative design of a current source shown in FIG. 1 according to an embodiment of the present disclosure.

FIG. 6 is a diagram illustrating a third alternative design of a current source shown in FIG. 1 according to an embodiment of the present disclosure.

FIG. 7 is a diagram illustrating a second switching regulator circuit according to an embodiment of the present disclosure.

FIG. 8 is a diagram illustrating a third switching regulator circuit according to a second embodiment of the present disclosure.

FIG. 9 is a diagram illustrating a fourth switching regulator circuit according to an embodiment of the present disclosure.

FIG. 10 is a diagram illustrating a fifth switching regulator circuit according to an embodiment of the present disclosure.

FIG. 11 is a diagram illustrating a sixth switching regulator circuit according to an embodiment of the present disclosure.

FIG. 12 is a diagram illustrating a seventh switching regulator circuit according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

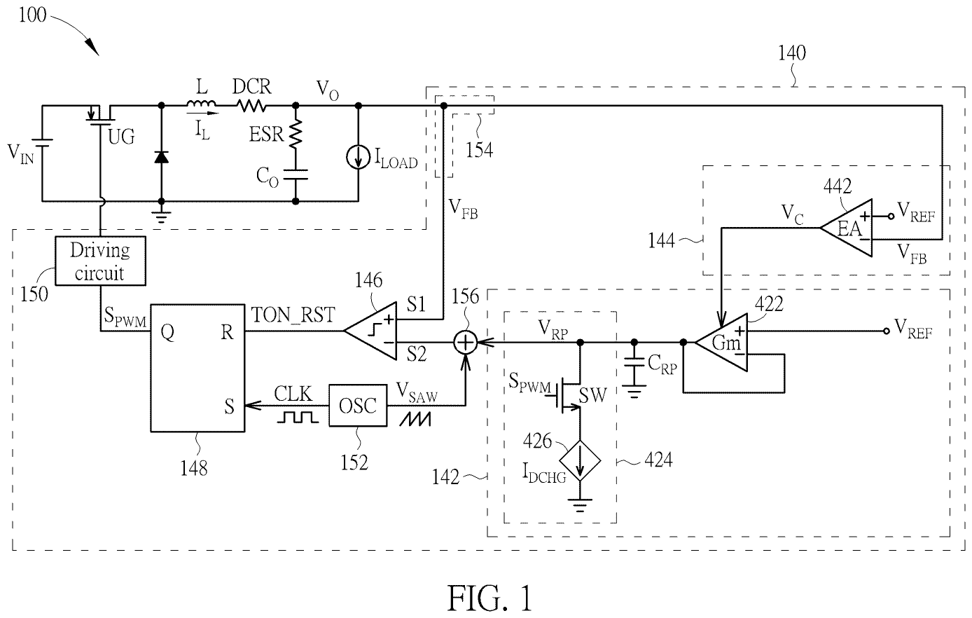

FIG. 1 is a diagram illustrating a first switching regulator circuit according to an embodiment of the present disclosure. The switching regulator circuit 100 is a voltage converter circuit operating under a PWM mode. The switching regulator circuit 100 is utilized for converting an input voltage V_{IN} into an output voltage V_{O}, and accordingly providing a load current I_{LOAD} for a load. The input voltage V_{IN} may be supplied from a power source such as a battery. The load may be any electronic device that consumes electricity. By way of example, but not limitation, the switching regulator circuit 100 may be a DC-to-DC buck converter for generating the output voltage V_{O} that is lower than the input voltage V_{IN}. The switching regulator circuit 100 may include a main switch (e.g., a high-side power switch) UG, an inductor L, a direct current resistor DCR of the inductor L, an output capacitor Co, an equivalent series resistor ESR of the output capacitor Co, and a control circuit 140. The control circuit 140 may include a reference signal generation circuit 142, an offset control circuit 144, a comparator circuit 146, a PWM control circuit 148, a driving circuit 150, an oscillator circuit (labeled by “OSC”) 152, a feedback circuit 154, and a combining circuit 156. The offset control circuit 144 may be optional. That is, in some embodiments, the offset control circuit 144 may be omitted from the control circuit 140. To put it simply, any switching regulator circuit with a control circuit using the proposed reference signal generation circuit falls within the scope of the present disclosure.

The reference signal generation circuit 142 is configured to receive at least a reference voltage V_{REF} and a PWM signal S_{PWM}, and generate an adjusted reference voltage V_{RP} according to at least the reference voltage V_{REF} and the PWM signal S_{PWM}. In some embodiments, the reference signal generation circuit 142 may further receive the input voltage V_{IN} of the switching regulator circuit 100, and generate the adjusted reference voltage V_{RP} according to the reference voltage V_{REF}, the PWM signal S_{PWM}, and the input voltage V_{IN}. The oscillator circuit 152 is configured to generate a sawtooth wave signal V_{SAW} and a clock signal CLK with a fixed frequency. The feedback circuit 154 is configured to generate a feedback voltage V_{FB} according to the output voltage V_{O} of the switching regulator circuit 100. In this embodiment, the feedback circuit 154 is configured to feed back the output voltage V_{O} as the feedback voltage V_{FB} (i.e., V_{FB}=V_{O}). For example, the feedback circuit 154 may be implemented using conductive lines.

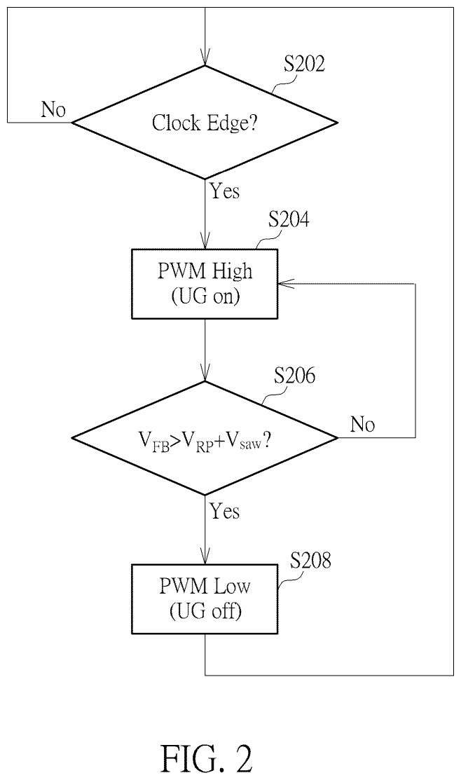

The comparator circuit 146 has an input terminal (labeled by “+”) configured to receive an input signal S1 derived from the feedback voltage V_{FB}, another input terminal (labeled by “−”) configured to receive an input signal S2 derived from an output of the combining circuit 156, and an output terminal configured to generate and output a comparison signal TON_RST to the PWM control circuit 148. In this embodiment, the feedback voltage V_{FB} acts as the input signal S1 (i.e., S1=V_{FB}=V_{O}); and the combining circuit 156 may be implemented using an adder circuit, and is configured to combine the adjusted reference voltage V_{RP} and the sawtooth wave signal V_{SAW} to generate an adjusted sawtooth wave signal as the input signal S2 (i.e., S2=V_{SAW}+V_{RP}). The PWM control circuit 148 may be implemented using a set-reset (SR) latch, where a reset terminal (labeled by “R”) is configured to receive the comparison signal TON_RST, a set terminal (labeled by “S”) is configured to receive the clock signal CLK, and a data output terminal (labeled by “Q”) is configured to output the PWM signal S_{PWM}. The driving circuit 150 is configured to receive the PWM signal S_{PWM}, and control operations of the main switch UG (i.e., ON/OFF status of main switch UG) according to the duty cycle of the PWM signal S_{PWM}, where the duty cycle of the PWM signal S_{PWM} decides an on-time duration of the main switch UG. FIG. 2 is a flowchart illustrating a PWM control scheme of the switching regulator circuit 100 according to an embodiment of the present disclosure. When the set terminal (labeled by “S”) is triggered by a rising edge of the clock signal CLK, the PWM control circuit 148 sets a logic high level at the data output terminal (labeled by “Q”), such that the main switch UG is switched on (steps S202 and S204). When the reset terminal (labeled by “R”) is triggered by a rising edge of the comparison signal TON_RST due to the input signal S1 (e.g., S1=V_{FB}=V_{O}) being larger than the input signal S2 (e.g., S2=V_{SAW}+V_{RP}), the PWM control circuit 148 sets a logic low level at the data output terminal (labeled by “Q”), such that the main switch UG is switched off (steps S206 and S208).

The reference signal generation circuit 142 is designed to generate the adjusted reference voltage V_{RP}, where there is a fixed relation between the adjusted reference voltage V_{RP} and the inductor current IL. Hence, the adjusted reference voltage V_{RP} may act as an estimator of the inductor current IL. For example, the waveform of the adjusted reference voltage V_{RP} is equal to the waveform of an inversion of the inductor current IL. Hence, in this embodiment, the adjusted reference voltage V_{RP} is applied to the input signal S2 at the input terminal (labeled by “−”) through the combining circuit 156. The reference signal generation circuit 142 may include an operational amplifier circuit 422, a compensation capacitor CRP, and a compensation branch circuit 424. A non-inverting input terminal (labeled by “+”) of the operational amplifier circuit 422 is configured to receive the reference voltage V_{REF}. The reference voltage V_{REF} may be generated by a voltage generator or a bandgap voltage reference circuit (not shown). The reference voltage V_{REF} may be a fixed value, and may be set in accordance with practical requirements. An inverting input terminal (labeled by “−”) of the operational amplifier circuit 422 is coupled to an output terminal of the operational amplifier circuit 422. The adjusted reference voltage V_{RP} is generated at the output terminal of the operational amplifier circuit 422. In other words, the operational amplifier circuit 422 controls the adjusted reference voltage V_{RP} according to the reference voltage V_{REF}. In this embodiment, the operational amplifier circuit 422 may be an operational transconductance amplifier (OTA). In addition, the operational amplifier circuit 422 is configured to act as a unity gain buffer for buffering the reference voltage V_{REF} received by the non-inverting input terminal (labeled by “+”) of the operational amplifier circuit 422 and outputting the adjusted reference voltage V_{RP}.

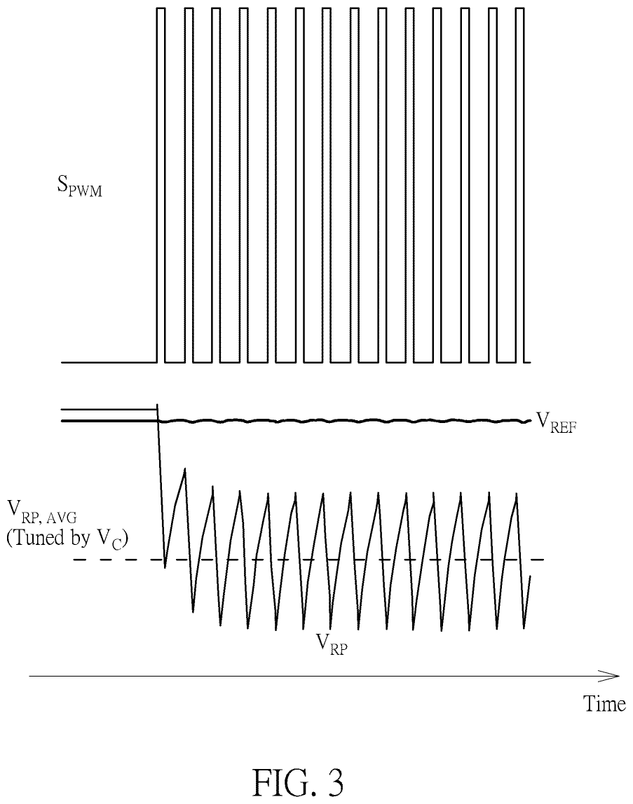

The compensation capacitor CRP is coupled between the output terminal of the operational amplifier circuit 422 and a reference terminal (e.g., a ground terminal). Moreover, the compensation branch circuit 424 is coupled between the output terminal of the operational amplifier circuit 422 and the same reference terminal (e.g., ground terminal). The compensation branch circuit 424 may include an auxiliary switch SW and a current source 426 connected in series. The auxiliary switch SW is controlled by the PWM signal S_{PWM} generated by the PWM control circuit 148. For example, during a high-level duration of the PWM signal S_{PWM}, the auxiliary switch SW and the main switch UG are both switched on; and during a low-level duration of the PWM signal S_{PWM}, the auxiliary switch SW and the main switch UG are both switched off. The auxiliary switch SW may be a metal-oxide semiconductor field-effect transistor (MOSFET), or a bipolar junction transistor (BJT), or other element with similar function. The current source 426 is configured to generate a current I_{DCHG}. When the auxiliary switch SW is switched on, the current I_{DCHG} discharges the compensation capacitor CRP so as to adjust the level of the adjusted reference voltage V_{RP}. In this embodiment, the current source 426 may be implemented using a constant current source. In other words, the compensation branch circuit 424 is controlled by the PWM signal S_{PWM} to periodically discharge the compensation capacitor CRP. FIG. 3 is a diagram illustrating waveforms of the PWM signal S_{PWM} and the adjusted reference voltage V_{RP} according to an embodiment of the present disclosure. When the auxiliary switch SW and the main switch UG are both switched on due to S_{PWM}=High, the inductor current IL may gradually increase, and the adjusted reference voltage V_{RP} may gradually decrease. When the auxiliary switch SW and the main switch UG are both off due to S_{PWM}=LOW, the inductor current IL may gradually decrease, and the adjusted reference voltage V_{RP} may gradually increase.

The control circuit 140 may include additional components to achieve other designed functions. For example, the offset control circuit 144 may be used to ensure that an average of the feedback voltage V_{FB} (e.g., V_{FB}=V_{O}) is equal to or close to the reference voltage V_{REF}. As shown in FIG. 1, the offset control circuit 144 may include an error amplifier 442. An inverting input terminal (labeled by “−”) of the error amplifier 442 is configured to receive the feedback voltage V_{FB} that can reflect the output voltage V_{O}. A non-inverting input terminal (labeled by “+”) of the error amplifier 442 is configured to receive the reference voltage V_{REF}. An output terminal of the error amplifier 442 is coupled to an offset control terminal of the operational amplifier circuit 422. Specifically, the operational amplifier circuit 422 may be an OTA buffer with offset adjustment. The error amplifier 442 is configured to generate an error signal V_{C} according to the feedback voltage V_{FB} (e.g., V_{FB}=V_{O}) and the reference voltage V_{REF}, and provide the error signal V_{C} to the offset control terminal of the operational amplifier circuit 422. The error amplifier 442 may be a high gain amplifier circuit that can amplify small differences between signals into larger signals. During operations of the switching regulator circuit 100, the error amplifier 442 performs error accumulation and continuously accumulates the difference between the signals at the two input terminals (i.e., feedback voltage V_{FB} and reference voltage V_{REF}) to generate the error signal V_{C}. The error signal V_{C} may be positive or negative, depending upon the difference between feedback voltage V_{FB} and reference voltage V_{REF}. The adjusted reference voltage V_{RP} output from the operational amplifier circuit 422 may be determined based on the reference voltage V_{REF} and an offset voltage V_{off} of the operational amplifier circuit 422 (i.e., V_{RP}=V_{REF}+V_{off}), where the offset voltage V_{off} of the operational amplifier circuit 422 may be adjusted according to the error signal V_{C} generated based on the feedback voltage V_{FB} (e.g., V_{FB}=V_{O}) and the reference voltage V_{REF}. For example, V_{off}=V_{C}*K, where K is a gain value.

During operations of the switching regulator circuit 100, when the feedback voltage V_{FB} (e.g., V_{FB}=V_{O}) is lower than the reference voltage V_{REF}, the level of the error signal V_{C} generated by the error amplifier 442 may gradually increase. As the level of the error signal V_{C} increases, the offset voltage V_{off} of the operational amplifier circuit 422 increases and accordingly the adjusted reference voltage V_{RP} also increases. Under such a situation, the input signal S2 may increase due to the adjusted reference voltage V_{RP}, and the output voltage V_{O} may rise accordingly. Finally, through the control of the offset control circuit 144, the feedback voltage V_{FB} (e.g., V_{FB}=V_{O}) and the reference voltage V_{REF} may be very close to or equal to each other. That is, an average of the output voltage V_{O} (e.g., V_{O}=V_{FB}) may be very close to or equal to the reference voltage V_{REF}, thus effectively improving the output voltage accuracy.

Regarding the embodiment shown in FIG. 1, the current source 426 may be implemented using a constant current source that provides a constant current I_{DCHG} as the discharging current. However, this is for illustrative purposes only.

FIG. 4 is a diagram illustrating a first alternative design of the current source 426 shown in FIG. 1 according to an embodiment of the present disclosure. The current source 426 of the reference signal generation circuit 142 is configured to generate a current I_{DCHG}, and when the auxiliary switch SW is switched on, the current I_{DCHG} discharges the compensation capacitor CRP SO as to adjust the adjusted reference voltage V_{RP}. As shown in FIG. 4, the current source 426 may include a controlled current source 428 and a voltage-to-current control circuit 430. The controlled current source 428 and the auxiliary switch SW are connected in series. The voltage-to-current control circuit 430 is coupled to the controlled current source 438. The voltage-to-current control circuit 430 is configured to receive a control voltage Vx, and control the controlled current source 428 to generate the controlled current I_{DCHG} according to the control voltage Vx. The magnitude of the controlled current I_{DCHG} depends on the setting of the control voltage Vx. If the transconductance gain of the voltage-to-current control circuit 430 is gm_DCHG and the on-time duration of the PWM signal S_{PWM} is TON, the controlled current I_{DCHG} may be equal to the product of the control voltage Vx and the transconductance gain gm_DCHG of the voltage-to-current control circuit 430 (i.e. I_{DCHG}=VX*gm_DCHG). Therefore, the amplitude A of the adjusted reference voltage V_{RP} may be expressed using the following equation:

$$A = {T}_{ON} * ( \frac{Vx * gm\_DCHG}{{C}_{R P}} ) \qquad ( 1 )$$

According to the equation (1), one embodiment of the present disclosure may set the control voltage Vx according to system requirements so as to adjust the amplitude A of the adjusted reference voltage V_{RP}. For example, the control voltage Vx may be set by the input voltage V_{IN} (i.e., Vx=V_{IN}) of the switching regulator circuit 100.

FIG. 5 is a diagram illustrating a second alternative design of the current source 426 shown in FIG. 1 according to an embodiment of the present disclosure. As shown in FIG. 5, the current source 426 may include a resistor R. When the auxiliary switch SW is switched on, the current I_{DCHG} flows through the compensation capacitor CRP, and the auxiliary switch SW and the resistor R form a discharge path for discharging the compensation capacitor CRP, such that the level of the adjusted reference voltage V_{RP} may be adjusted.

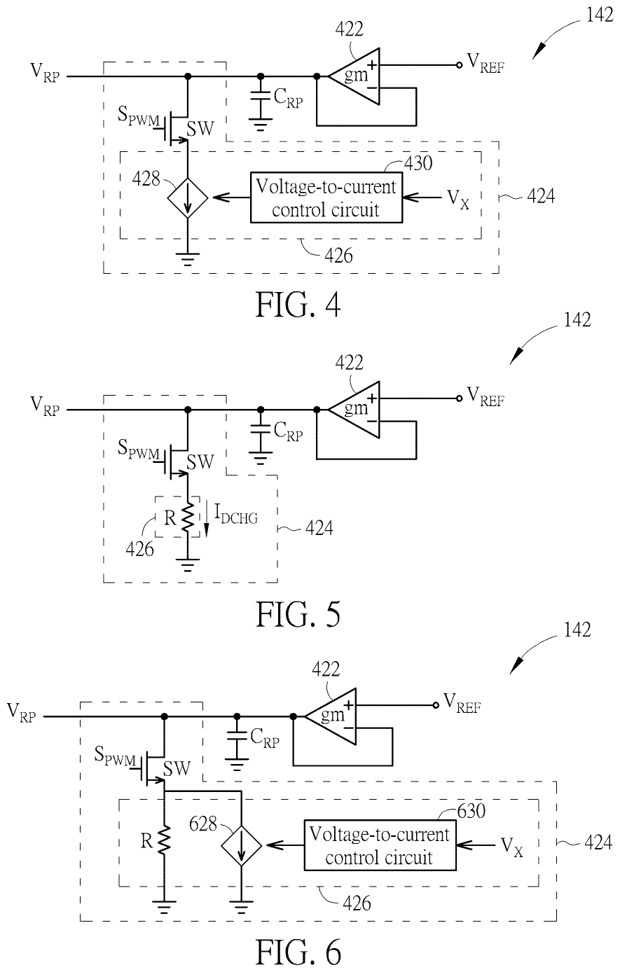

FIG. 6 is a diagram illustrating a third alternative design of the current source 426 shown in FIG. 1 according to an embodiment of the present disclosure. As shown in FIG. 6, the current source 426 may include a resistor R, a controlled current source 628 and a voltage-to-current control circuit 630. The resistor R and the auxiliary switch SW are connected in series. The controlled current source 628 is connected in parallel with the resistor R. The voltage-to-current control circuit 630 is coupled to the controlled current source 628. The voltage-to-current control circuit 630 is configured to control the controlled current source 628 to generate a controlled current according to a control voltage Vx, such that the current source 426 may output the current I_{DCHG}. Moreover, when the auxiliary switch SW is switched on, the current source 426 outputs the current I_{DCHG} and the current I_{DCHG} discharges the compensation capacitor CRP, so as to adjust the level of the adjusted reference voltage V_{RP}.

The feedback voltage V_{FB} is used to reflect the instant status of the output voltage V_{O} of the switching regulator circuit. Regarding the embodiment shown in FIG. 1, the feedback circuit 154 may be implemented using conductive lines that transmit the output voltage V_{O} as the feedback voltage V_{FB} required by the comparator circuit 146 and the error amplifier 442. In some embodiments of the present disclosure, the feedback voltage V_{FB} may be set by any voltage signal derived from the output voltage V_{O}.

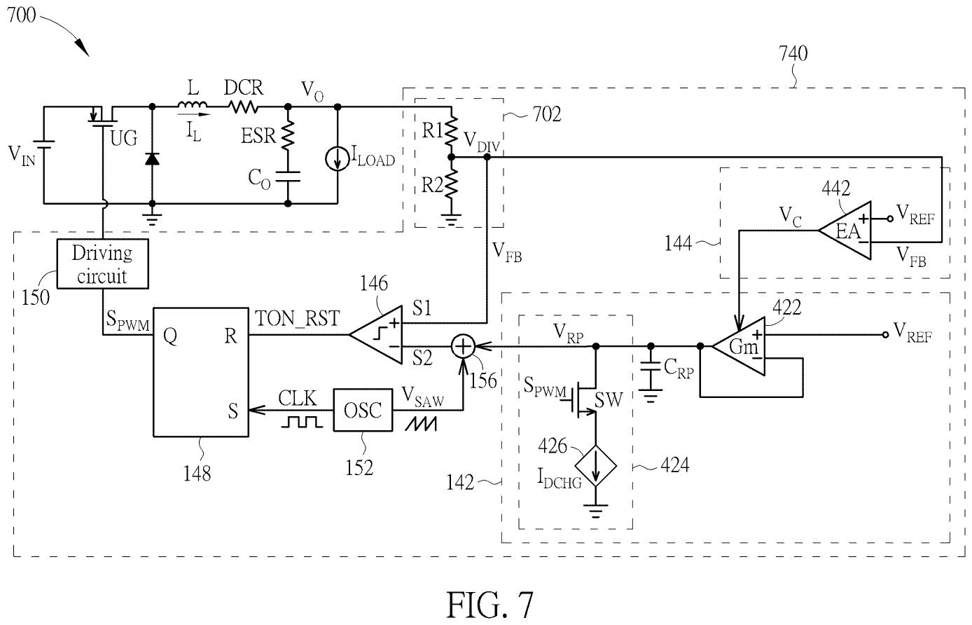

FIG. 7 is a diagram illustrating a second switching regulator circuit according to an embodiment of the present disclosure. The major difference between the switching regulator circuits 100 and 700 is that a feedback circuit of the switching regulator circuit 700 is implemented using a voltage divider circuit 702. The voltage divider circuit 702 includes series-connected resistors R1 and R2 between the output voltage V_{O} and a reference terminal (e.g., ground terminal). The resistance values of the resistors R1 and R2 may be set in accordance with practical requirements. The voltage divider circuit 702 is configured to perform voltage division upon the output voltage V_{O} to generate a divided voltage V_{DIV} as the feedback voltage V_{FB}

$$( i . e . , {V}_{F B} = {V}_{DIV} = {V}_{O} * \frac{R 2}{R 1 + R 2} ) .$$

The feedback voltage V_{FB} is positively correlated with the output voltage V_{O}, and is provided to the comparator circuit 146 and the error amplifier 442. With a proper setting of the reference voltage V_{REF}, the same objective of regulating the output voltage V_{O} at a desired voltage level is achieved by the switching regulator circuit 700.

For better comprehension of technical features of the proposed switching regulator circuit, the following assumes that the feedback voltage V_{FB} is set by the output voltage V_{O}. However, a person skilled in the art should readily appreciate that the feedback voltage V_{FB} may be replaced by any voltage signal (e.g., V_{DIV} shown in FIG. 7) that is derived from the output voltage V_{O} and is indicative of the instant status of the output voltage V_{O}.

Regarding each of the embodiments shown in FIG. 1 and FIG. 7, the offset control circuit 144 generates and outputs the error signal V_{C} to the offset control terminal of the operational amplifier circuit 422, resulting in adjustment of the comparison signal TON_RST output from the comparator circuit 146. However, these are for illustrative purposes only. In practice, any means capable of adjusting the comparison signal TON_RST by injection of the error signal V_{C} can be adopted.

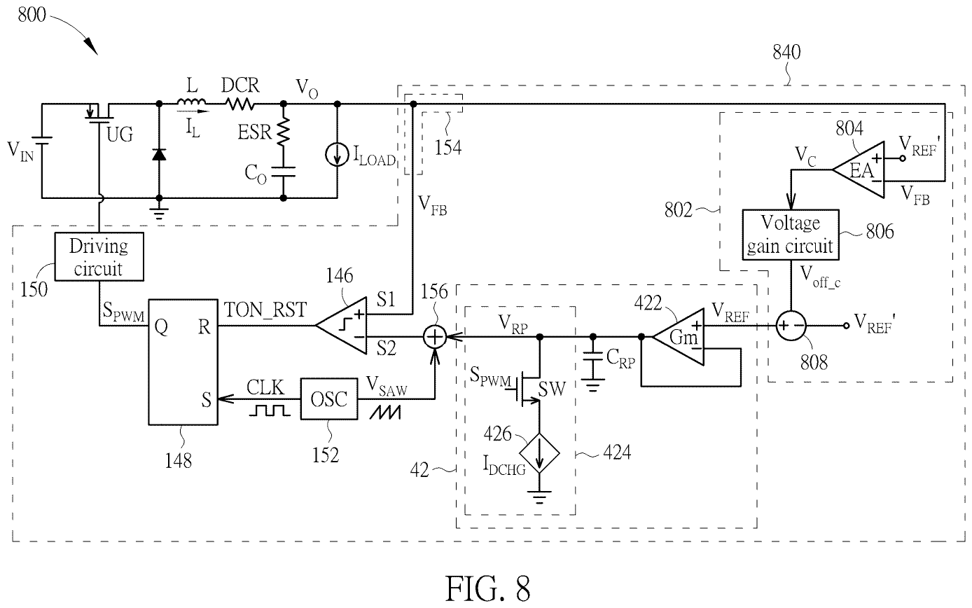

FIG. 8 is a diagram illustrating a third switching regulator circuit according to a second embodiment of the present disclosure. The components in the switching regulator circuit 800 shown in FIG. 8 with the same reference numerals as those in the switching regulator circuit 100 shown in FIG. 1 have same or similar operations and functions, and further description is omitted here for brevity. Compared to the switching regulator circuit 100 shown in FIG. 1, the switching regulator circuit 800 has the control circuit 840 with an offset control circuit 802 that does not output the error signal V_{C} to the offset control terminal of the operational amplifier circuit 422. In this embodiment, the offset control circuit 802 includes an error amplifier 804, a voltage gain circuit 806 and a combining circuit (e.g., an adder circuit) 808. The error amplifier 804 may be a high gain amplifier circuit. An inverting input terminal (labeled by “−”) of the error amplifier 804 is configured to receive the feedback voltage V_{FB} that can reflect the instant status of the output voltage V_{O}. For example, as shown in FIG. 8, the feedback circuit 154 feeds back the output voltage V_{O} as the feedback voltage V_{FB}. A non-inverting input terminal (labeled by “+”) of the error amplifier 804 is configured to receive a reference voltage V_{REF}′. An output terminal of the error amplifier 804 is coupled to the voltage gain circuit 806. The error amplifier 804 is configured to generate and output an error signal V_{C} to the voltage gain circuit 806 according to the feedback voltage V_{FB} (e.g., V_{FB}=V_{O}) and the reference voltage V_{REF}′. The voltage gain circuit 806 is coupled to the error amplifier 804 and configured to amplify the error signal V_{C} to generate an offset compensation signal V_{off_c}. The offset compensation signal V_{off_c} may be determined according to the error signal V_{C}. For example, the offset compensation signal V_{off_c} may be the product of the error signal V_{C} and a gain value. The combining circuit 808 is coupled to the voltage gain circuit 806 and the non-inverting input terminal (labeled by “+”) of the operational amplifier circuit 422. The combining circuit 808 is configured to combine the offset compensation signal V_{off_c} and the reference voltage V_{REF}′ to generate and output the reference voltage V_{REF} to the non-inverting input terminal (labeled by “+”) of the operational amplifier circuit 422.

During operations of the switching regulator circuit 800, when the feedback voltage V_{FB} (e.g., V_{FB}=V_{O}) is lower than the reference voltage V_{REF}′, the level of the error signal V_{C} generated by the error amplifier 804 may increase. When the error signal V_{C} increases, the offset compensation signal V_{off_c} increases, and the adjusted reference voltage V_{RP} also increases accordingly. Therefore, through the control of the comparator circuit 146, the output voltage V_{O} may rise. As a result, through the control of the offset control circuit 802, the average of the feedback voltage V_{FB} (e.g., V_{FB}=V_{O}) may be very close to or equal to the reference voltage V_{REF}′, thus effectively improving the output voltage accuracy. The reference voltage V_{REF}′ may be a fixed value, and may be set in accordance with practical requirements.

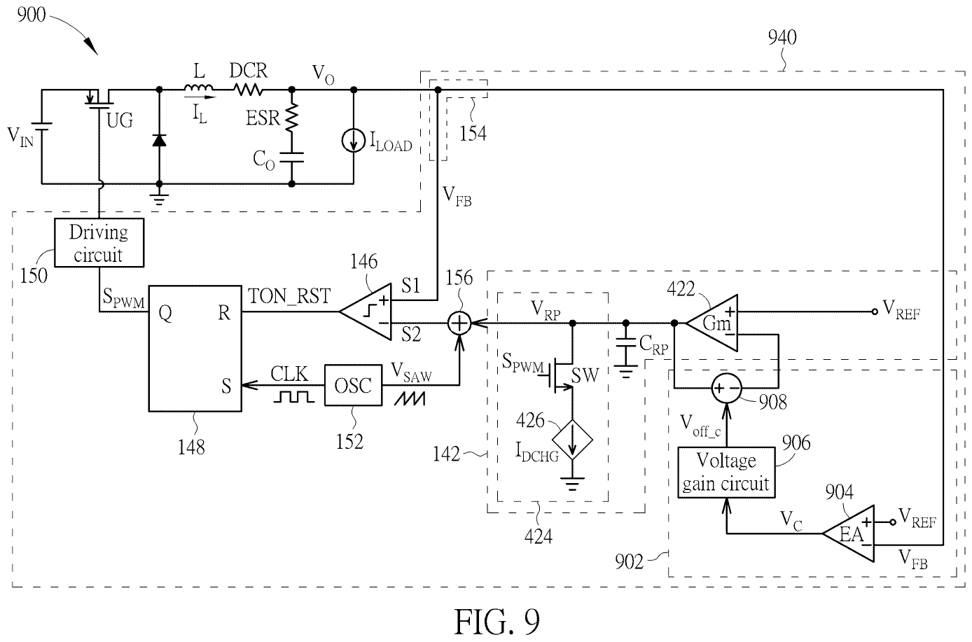

FIG. 9 is a diagram illustrating a fourth switching regulator circuit according to an embodiment of the present disclosure. The components in the switching regulator circuit 900 shown in FIG. 9 with the same reference numerals as those in the switching regulator circuit 100 shown in FIG. 1 have same or similar operations and functions, and further description is omitted here for brevity. Compared to the switching regulator circuit 100 shown in FIG. 1, the switching regulator circuit 900 has the control circuit 940 with an offset control circuit 902 that does not output the error signal V_{C} to the offset control terminal of the operational amplifier circuit 422. The offset control circuit 902 includes an error amplifier 904, a voltage gain circuit 906 and a combining circuit (e.g., an adder circuit) 908. The error amplifier 904 may be a high gain amplifier circuit. The error amplifier 904 is configured to generate and output an error signal V_{C} to the voltage gain circuit 906 according to the feedback signal V_{FB} (which can reflect the instant status of the output voltage V_{O}) and the reference voltage V_{REF}. The voltage gain circuit 906 is configured to amplify the error signal V_{C} to generate an offset compensation signal V_{off_c}. The offset compensation signal V_{off_c} may be determined according to the error signal V_{C}. For example, the offset compensation signal V_{off_c} may be the product of the error signal V_{C} and a gain value. The combining circuit 908 is coupled to the voltage gain circuit 906, the inverting input terminal (labeled by “−”) of the operational amplifier circuit 422, and the output terminal of the operational amplifier circuit 422, such that the operational amplifier circuit 422 may generate the adjusted reference voltage V_{RP} according to the reference voltage V_{REF} and the offset compensation signal V_{off_c}. Therefore, through the control of the offset control circuit 902, the average of the feedback voltage V_{FB} (e.g., V_{FB}=V_{O}) may be very close to or equal to the reference voltage V_{REF}, thus effectively improving the output voltage accuracy.

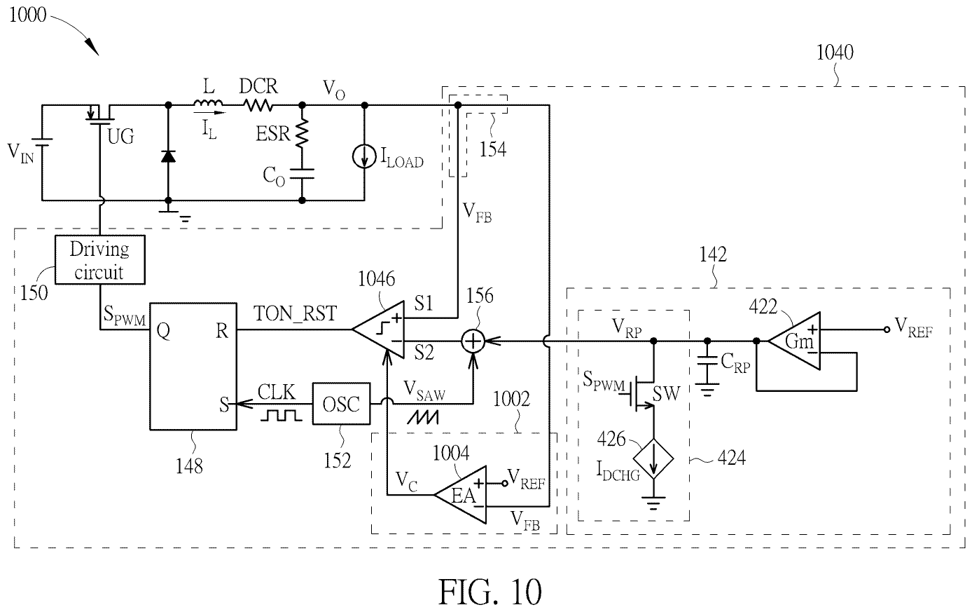

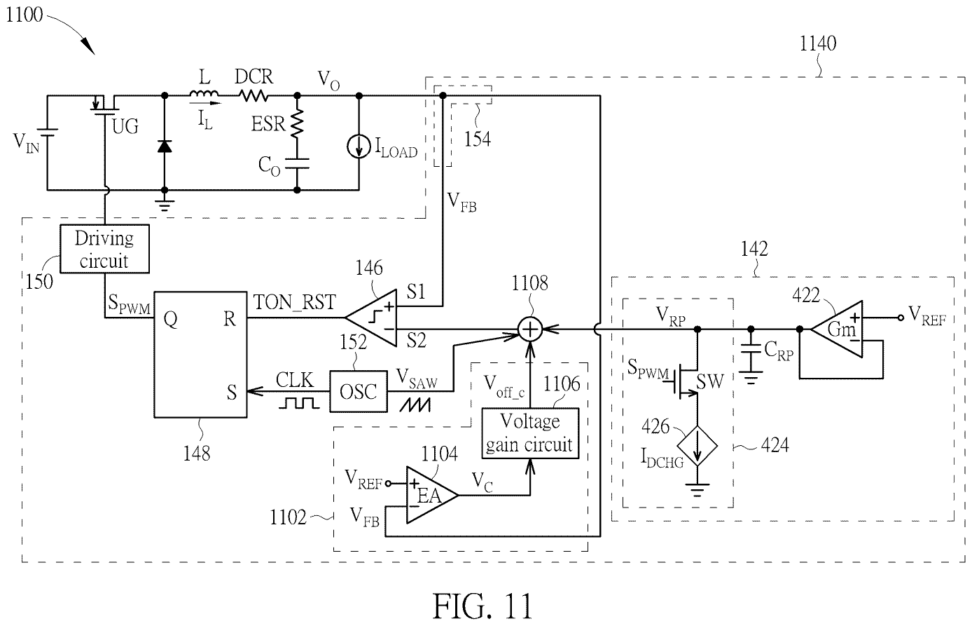

FIG. 10 is a diagram illustrating a fifth switching regulator circuit according to an embodiment of the present disclosure. The components in the switching regulator circuit 1000 shown in FIG. 10 with the same reference numerals as those in the switching regulator circuit 100 shown in FIG. 1 have same or similar operations and functions, and further description is omitted here for brevity. Compared to the switching regulator circuit 100 shown in FIG. 1, the switching regulator circuit 1000 has the control circuit 1040 with a comparator circuit 1046 with an offset control terminal and an offset control circuit 1002 that does not output the error signal V_{C} to the offset control terminal of the operational amplifier circuit 422. The offset control circuit 1002 includes an error amplifier 1004. The error amplifier 1004 may be a high gain amplifier circuit. The error amplifier 1004 is configured to generate and output an error signal V_{C} to the offset control terminal of the comparator circuit 1046 according to the feedback voltage V_{FB} (e.g., V_{FB}=V_{O}) and the reference voltage V_{REF}. The comparator circuit 1046 is configured to generate the comparison signal TON_RST according to the error signal V_{C}, the input signal S1 (e.g., S1=V_{FB}), and the input signal S2 (e.g., S2=V_{SAW}+V_{RP}). The comparison signal TON_RST may be determined according to the input signals S1, S2 and an offset voltage V_{off1} of the comparator circuit 1046. The offset voltage V_{off1} of the comparator circuit 1046 may be adjusted according to the error signal V_{C} generated based on the feedback voltage V_{FB} (e.g., V_{FB}=V_{O}) and the reference voltage V_{REF}. Through the control of the offset control circuit 1002, the average of the feedback voltage V_{FB} (e.g., V_{FB}=V_{O}) may be very close to or equal to the reference voltage V_{REF}, thus effectively improving the output voltage accuracy.

FIG. 11 is a diagram illustrating a sixth switching regulator circuit according to an embodiment of the present disclosure. The components in the switching regulator circuit 1100 shown in FIG. 11 with the same reference numerals as those in the switching regulator circuit 100 shown in FIG. 1 have same or similar operations and functions, and further description is omitted here for brevity. Compared to the switching regulator circuit 100 shown in FIG. 1, the switching regulator circuit 1100 has the control circuit 1140 with a combining circuit (e.g., an adder circuit) 1108 with three input nodes and an offset control circuit 1102 that does not output the error signal V_{C} to the offset control terminal of the operational amplifier circuit 422. The offset control circuit 1102 includes an error amplifier 1104 and a voltage gain circuit 1106. The error amplifier 1104 may be a high gain amplifier circuit. The error amplifier 1104 is configured to generate and output an error signal V_{C} to the voltage gain circuit 1106 according to the feedback voltage V_{FB} (which can reflect the instant status of the output voltage V_{O}) and the reference voltage V_{REF}. The voltage gain circuit 1106 is configured to amplify the error signal V_{C} to generate an offset compensation signal V_{off_c}. The offset compensation signal V_{off_c} may be determined according to the error signal V_{C}. For example, the offset compensation signal V_{off_c} may be the product of the error signal V_{C} and a gain value. The combining circuit 1108 is coupled to the voltage gain circuit 1106, the output terminal of the operational amplifier circuit 422 and the oscillator circuit 152, and configured to combine the sawtooth wave signal V_{SAW}, the offset compensation signal V_{off_c} and the adjusted reference voltage V_{RP} to generate the input signal S2 at the input terminal (labeled by “−”) of the comparator circuit 146. Therefore, through the control of the offset control circuit 1102, the average of the feedback voltage V_{FB} (e.g., V_{FB}=V_{O}) may be very close to or equal to the reference voltage V_{REF}, thus effectively improving the output voltage accuracy.

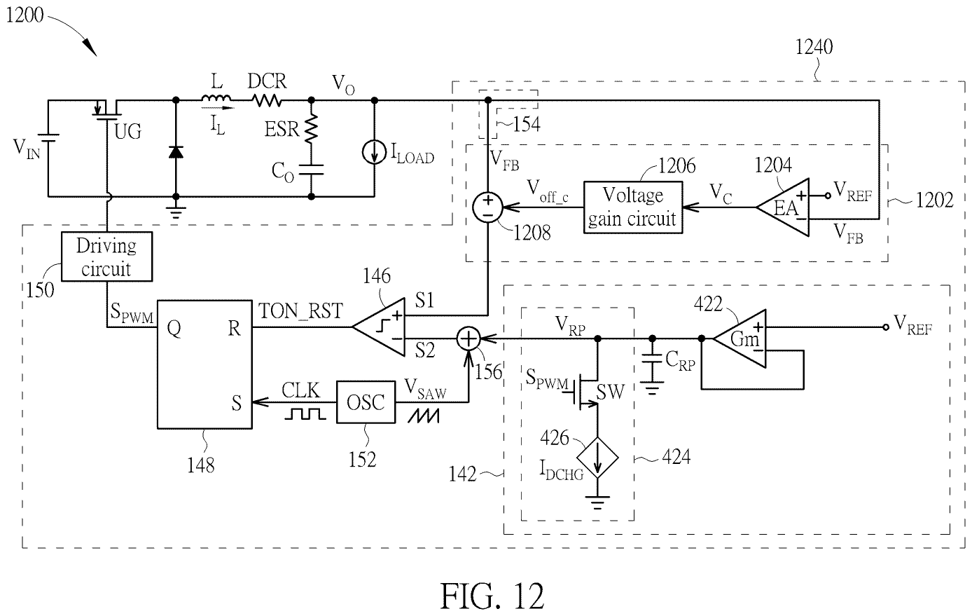

FIG. 12 is a diagram a seventh switching regulator circuit according to an embodiment of the present disclosure. The components in the switching regulator circuit 1200 shown in FIG. 12 with the same reference numerals as those in the switching regulator circuit 100 shown in FIG. 1 have same or similar operations and functions, and further description is omitted here for brevity. Compared to the switching regulator circuit 100 shown in FIG. 1, the switching regulator circuit 1200 has the control circuit 1240 with an offset control circuit 1202 that does not output the error signal V_{C} to the offset control terminal of the operational amplifier circuit 422. The offset control circuit 1202 includes an error amplifier 1204, a voltage gain circuit 1206 and a combining circuit (e.g., an adder circuit) 1208. The error amplifier 1204 may be a high gain amplifier circuit. The error amplifier 1204 is configured to generate and output an error signal V_{C} to the voltage gain circuit 1206 according to the feedback voltage V_{FB} (e.g., V_{FB}=V_{O}) and the reference voltage V_{REF}. The voltage gain circuit 1206 is configured to amplify the error signal V_{C} to generate an offset compensation signal V_{off_c}. The combining circuit 1208 is coupled to the output voltage V_{O}, the voltage gain circuit 1206 and the input terminal (labeled by “+”) of the comparator circuit 146. The combining circuit 1208 is configured to combine the offset compensation signal V_{off_c} and the feedback voltage V_{FB} (e.g., V_{FB}=V_{O}) to generate the input signal S1 at the input terminal (labeled by “+”) of the comparator circuit 146. Therefore, through the control of the offset control circuit 1202, the average of the feedback voltage V_{FB} (e.g., V_{FB}=V_{O}) may be very close to or equal to the reference voltage V_{REF}, thus effectively improving the output voltage accuracy.

It should be noted that each of the embodiments shown in FIG. 8-FIG. 12 may be modified to have the feedback circuit 154 replaced by the voltage divider circuit 702 that feeds back the divided voltage V_{DIV} as the feedback voltage V_{FB}. These alternative designs all fall within the scope of the present disclosure.

In above embodiments, any of the error amplifiers 442, 804, 904, 1004, 1104, 1204 is allowed to be implemented using a Type-I compensator. In this way, the hardware cost of the switching regulator circuit can be reduced due to the use of simple compensation. However, this is for illustrative purposes only. In some embodiments, any of the error amplifiers 442, 804, 904, 1004, 1104, 1204 may be implemented using a Type-II compensator or a Type-III compensator, depending upon actual design considerations. These alternative designs all fall within the scope of the present invention.

Compared to a conventional voltage regulator circuit using voltage-mode PWM control, the proposed switching regulator circuit provides a feedback voltage to a PWM comparator circuit without via a high gain amplifier circuit, and therefore has a fast transient response. Compared to a conventional voltage regulator circuit using peak current mode PWM control, the proposed switching regulator circuit uses a reference signal generation circuit to obtain estimation of the inductor current without the need of a high-side current sensor, and has a fast transient response. Compared to a conventional voltage regulator circuit using RBCOT control or V²COT control, the proposed switching regulator circuit uses PWM control and operates under a fixed frequency.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A control circuit of a switching regulator circuit, comprising:
a reference signal generation circuit, configured to generate an adjusted reference voltage according to a first reference voltage and a pulse-width modulation (PWM) signal;
an oscillator circuit, configured to generate a sawtooth wave signal and a clock signal;
a feedback circuit, configured to generate a feedback voltage according to an output voltage of the switching regulator circuit;
a combining circuit, configured to combine the adjusted reference voltage and the sawtooth wave signal to generate an adjusted sawtooth wave signal;
a comparator circuit, comprising a first input terminal configured to receive a first input signal derived from the feedback voltage, a second input terminal configured to receive a second input signal derived from the adjusted sawtooth wave signal, and an output terminal configured to output a comparison signal; and
a PWM control circuit, configured to generate the PWM signal according to the comparison signal and the clock signal.

2. The control circuit of claim 1, wherein the feedback circuit is configured to feed back the output voltage of the switching regulator circuit as the feedback voltage.

3. The control circuit of claim 1, wherein the feedback circuit comprises:
a voltage divider circuit, configured to perform voltage division upon the output voltage of the switching regulator circuit to generate a divided voltage as the feedback voltage.

4. The control circuit of claim 1, wherein the reference signal generation circuit comprises:
an operational amplifier circuit, comprising a non-inverting input terminal configured to receive the first reference voltage, an inverting input terminal, and an output terminal coupled to the inverting input terminal of the operational amplifier circuit, wherein the adjusted reference voltage is generated at the output terminal of the operational amplifier circuit;
a compensation capacitor, coupled between the output terminal of the operational amplifier circuit and a reference terminal; and
a compensation branch circuit, coupled between the output terminal of the operational amplifier circuit and the reference terminal, wherein the compensation branch circuit is configured to control the adjusted reference voltage according to the PWM signal.

5. The control circuit of claim 4, wherein the compensation branch circuit comprises an auxiliary switch and a current source connected in series.

6. The control circuit of claim 5, wherein the auxiliary switch is controlled by the PWM signal.

7. The control circuit of claim 6, wherein the reference terminal is a ground terminal; and the compensation capacitor is discharged by a current provided by the current source when the auxiliary switch is turned on by the PWM signal.

8. The control circuit of claim 5, wherein the current source of the compensation branch circuit is a constant current source.

9. The control circuit of claim 5, wherein the current source of the compensation branch circuit comprises:
a controlled current source, connected in series with the auxiliary switch; and
a voltage-to-current control circuit, configured to control the controlled current source to output a controlled current according to a control voltage.

10. The control circuit of claim 9, wherein the control voltage is an input voltage of the switching regulator circuit.

11. The control circuit of claim 5, wherein the current source of the compensation branch circuit comprises:
a resistor, connected in series with the auxiliary switch.

12. The control circuit of claim 5, wherein the current source of the compensation branch circuit comprises:
a resistor, connected in series with the auxiliary switch;
a controlled current source, connected in parallel with the resistor; and
a voltage-to-current control circuit, configured to control the controlled current source to output a controlled current according to a control voltage.

13. The control circuit of claim 12, wherein the control voltage is an input voltage of the switching regulator circuit.

14. The control circuit of claim 4, further comprising:
an offset control circuit, comprising:
an error amplifier, configured to generate and output an error signal to an offset control terminal of the operational amplifier circuit according to the feedback voltage and the first reference voltage;
wherein the operational amplifier circuit is configured to control the adjusted reference voltage according to the first reference voltage and the error signal; the adjusted reference voltage is determined according to the first reference voltage and an offset voltage of the operational amplifier circuit; and the offset voltage is adjusted according to the error signal generated based on the feedback voltage and the first reference voltage.

15. The control circuit of claim 4, further comprising:
an offset control circuit, comprising:
an error amplifier, configured to generate an error signal according to the feedback voltage and a second reference voltage;
a voltage gain circuit, configured to amplify the error signal to generate an offset compensation signal; and
a combining circuit, configured to combine the offset compensation signal and the second reference voltage to generate and output the first reference voltage to the non-inverting input terminal of the operational amplifier circuit.

16. The control circuit of claim 4, further comprising:
an offset control circuit, comprising:
an error amplifier, configured to generate an error signal according to the feedback voltage and the first reference voltage;
a voltage gain circuit, configured to amplify the error signal to generate an offset compensation signal; and
a combining circuit, coupled to the voltage gain circuit, the inverting input terminal of the operational amplifier circuit and the output terminal of the operational amplifier circuit;
wherein the operational amplifier circuit is configured to generate the adjusted reference voltage according to the first reference voltage and the offset compensation signal.

17. The control circuit of claim 4, further comprising:
an offset control circuit, comprising:
an error amplifier, configured to generate an error signal to an offset control terminal of the comparator circuit according to the feedback voltage and the first reference voltage;
wherein the comparator circuit is configured to generate the comparison signal according to the error signal, the first input signal and the second input signal; the comparison signal is determined according to the first input signal, the second input signal and an offset voltage of the comparator circuit; and the offset voltage is adjusted according to the error signal generated based on the feedback voltage and the first reference voltage.

18. The control circuit of claim 4, further comprising:
an offset control circuit, comprising:
an error amplifier, configured to generate an error signal according to the feedback voltage and the first reference voltage;
a voltage gain circuit, configured to amplify the error signal to generate an offset compensation signal;
wherein the combining circuit is configured to combine the sawtooth wave signal, the offset compensation signal, and the adjusted reference voltage to generate the second input signal at the second input terminal of the comparator circuit.

19. The control circuit of claim 4, further comprising:
an offset control circuit, comprising:
an error amplifier, configured to generate an error signal according to the feedback voltage and the first reference voltage;
a voltage gain circuit, configured to amplify the error signal to generate an offset compensation signal; and
a combining circuit, configured to combine the offset compensation signal and the feedback voltage to generate the first input signal at the first input terminal of the comparator circuit.

20. A method for controlling a switching regulator circuit, comprising:
generating an adjusted reference voltage according to a reference voltage and a pulse-width modulation (PWM) signal;
generating a sawtooth wave signal and a clock signal;
generating a feedback voltage according to an output voltage of the switching regulator circuit;
combining the adjusted reference voltage and the sawtooth wave signal to generate an adjusted sawtooth wave signal;
comparing a first input signal derived from the feedback voltage and a second input signal derived from the adjusted sawtooth wave signal, to generate and output a comparison signal; and
generating the PWM signal according to the comparison signal and the clock signal.
